(19) United States
(12) Patent Application Publication
(10) Pub. No.: US 2015/0009486 A1
(43) Pub. Date: Jan. 8, 2015

(54) Imaging System

(71) Applicants: Alexander Potemkin, Barsbuttel (DE); Elena Ivanova Smirnova, Moscow (RU)

(72) Inventors: Alexander Potemkin, Barsbuttel (DE); Elena Ivanova Smirnova, Moscow (RU)

(73) Assignee: Alexander Potemkin, Barsbuttel (DE)

(21) Appl. No.: 14/351,048

(22) PCT Filed: Jul. 13, 2012
(86) PCT No.: PCT/IB2012/001393

§ 371 Date: Sep. 4, 2014

(30) Foreign Application Priority Data
Oct. 11, 2011 (EP) PCT/EP2011/005066

(51) Int. Cl. G01C 3/08; G01S 17/00; G01S 7/486

(52) U.S. Cl. CPC G01C 3/08; G01S 7/4861; G01S 17/00
USPC 356/4.01

(57) ABSTRACT

An imaging system is provided, having a housing, an inlet opening receiving radiation from objects and an optical system. The optical system includes a reception channel for visible radiation, an infra-red radiation channel, a channel of the laser range finder having a laser radiation source, a photoreceptor and spectral splitters. All channels are optically coupled to one another. An optical element made from a material that transmits the radiation in the working range of the photoreceptor and is inserted into the inlet opening to hermetically seal the system. The reception channel for the visible radiation and the infra-red radiation channel are constructed as an optoelectronic multichannel system having at least two channels, the optical axes of which coincide and are situated inside the inlet opening.

### CROSS REFERENCE TO RELATED APPLICATIONS

This application is a National Phase of PCT International Application No. PCT/IB2012/001393, filed Jul. 13, 2012, and PCT International Application No. PCT/EP2011/005066, filed Oct. 11, 2011, the entire disclosures of which are herein expressly incorporated by reference.

### TECHNICAL FIELD

The claimed utility model relates to the field of the design and manufacture of optoelectronic devices, i.e. range finders using a laser beam at any time of the day, and can be used in visual observation systems on ground based transport and watercraft transport, in fire fighting technology for measuring the size of the source of the fire and for determining the intensity of the fire, as well as in other technical fields.

### BACKGROUND ART

It is desirable to have the image of the target upon its detection and to have the exact distance or the distance between the object and the operator.

There are optical systems that secure either the visual shape and size (directly or TV) or the thermal image and that determine the distance between the target and the operator.

A dual channel optoelectronic system, comprising a first optoelectronic channel (the narrow field of view channel), which has an objective lens that is designed as a concave mirror with a retroreflector, is known from the prior art.

The second optoelectronic channel (wide field of view channel) has a refracting objective lens, which is inserted in front of the objective lens of the first optoelectronic module, and shares with the latter a common optical axis.

The first optoelectronic channel and the second optoelectronic channel have a common photodetector matrix (U.S. Pat. No. 5,161,051, 1990).

In the course of ensuring that the image of the object of the observation is received by means of two channels, the known optoelectronic system:
does not allow one and the same object to be observed simultaneously in the different spectral ranges using various image receivers at different image scales;
does not allow the distance of the target to be measured.

The prior art discloses a dual channel optoelectronic system, each channel of which has an objective lens and a photodetector matrix, which is arranged on the optical axis in the focal plane of the objective lens. In this case the objective lens of the first optoelectronic channel is configured as a mirror lens channel with central shielding; and the second optoelectronic channel is provided in front of the first optoelectronic channel and shares with the latter a common optical axis (RU no. 2091834, class G02B17/08, 1995).

The prior art optoelectronic system allows one and same object to be observed simultaneously in the different spectral ranges using various image receivers at different image scales.

However, the dual channel optoelectronic system known from the prior art has a high coefficient of central shielding. Not only does this feature result in a significant decrease in the light flux that passes through this optoelectronic system, but it is also associated with a significant distribution of the energy in the focusing plane, which in the final end degrades the degree of contrast and, thus, the image quality.

The known dual channel optoelectronic system does not allow the distance of the object to be measured in the different spectral ranges, because the system lacks the channel of a laser range finder.

The prior art discloses a laser range finder having a transmission module, comprising an optically coupled laser and an optical transmission system, consisting of a telescope and two rotary wedges, which are arranged in the output of the telescope; a sighting-receiving module, comprising an objective lens, a first spectral splitter, which is accommodated on the optical axis of the objective lens at an angle; a device for observing the image of objects with a sighting mark that is provided in the focal plane of the objective lens; and a photodetector, which is optically coupled by means of the first spectral splitter to the device for observing the image of objects; a collimator that is intended for the visible light and that is arranged parallel to the radiation axis of the laser and which is rigidly connected to said laser and which is optically coupled to the optical transmission system by means of two parallel flat mirrors, each of which is designed as a spectral splitter; and a retroreflector, which is used in the areas of the exit pupil of the transmission module and the entrance pupil of the sighting-receiving module, so that the module can be guided out of the light path (Eurasian patent no. 001581, class G01C3/08, 2001).

The known laser range finder offers the possibility of monitoring operationally the parallelism of the axes of the transmission channel and the sighting channel.

However, its drawback is in the following:
the complexity of the design: that is, the device has many components, the function of which has to be adapted, but such an adaptation is difficult to guarantee.
the low accuracy of the measurement of the distance of the target because of the impossibility of operationally monitoring the parallelism of the axes and the alignment of the sighting module and the receiving module. The probability that the sighting module and the receiving module will deviate during the setup of the range finder is quite high, since the angular field of the receiving module is usually the units of minutes of arc.
the sighting channel, which is intended for observing the image of objects and for targeting said objects, does not ensure the required image quality under severe weather conditions, especially at dusk, at night and in fog.

According to the core technical content of the claimed solution, the closest prior art is a visualization system comprising an input aperture, which is intended for receiving the radiation from objects, and an optical system, consisting of a receiving channel for the visible radiation, an infrared radiation channel and a channel of the laser range finder, comprising a laser radiation source, a photodetector and spectral splitters, wherein all of the channels are optically coupled to each other (WO 99/13355, class G01S 17/02, Mar. 18, 1999).

The drawbacks of the prior art system are as follows:
the presence of many spectral splitters, which decease the common light flux, which is directed onto each photodetector,
the complexity of the design,
the lack of a specific optical element that is transparent in the entire working range of the device and is arranged in the input aperture (the aperture) and protects against the influence of the ambient medium (the atmosphere).

### SUMMARY OF THE INVENTION

The technical result achieved by the present invention is the manufacture of a visualization system that makes it possible to measure the distance of the object as well as to sight both day and night through the use of the infrared viewing device as well as to simplify the design and construction.

The technical result is achieved in the claimed utility model by means of the manufacture of the visualization system, comprising an input aperture, which is intended for receiving the radiation from objects, and an optical system, consisting of a receiving channel for the visible radiation, an infrared radiation channel and a channel of the laser range finder, comprising a laser radiation source, a photodetector and spectral splitters, wherein all of the channels are optically coupled to each other, and said visualization system is provided, according to the utility model, with an optical element that is made from a material that transmits the radiation in the working range of the photodetectors, and this optical element is used in the input aperture, which is intended for hermetically sealing the system, whereas the receiving channel for the visible radiation and the infrared radiation channel are designed as a multi-channel optoelectronic system that comprises at least two channels, the optical axes of which are coincident with each other and are located inside the input aperture.

The design of both the receiving channel for the visible radiation and the infrared radiation channel as a multi-channel optoelectronic system makes it possible to reduce the outside dimensions of the system and to use one and the same objective lens for guiding the laser beam out and for receiving the laser beam.

The manufacture of the optical element from zinc selenide or zinc sulfide ensures the wide passband, the low scattering factor, the high mechanical properties, and the low price of the optical element.

The arrangement of the receiving channel for the visible radiation in front of the infrared radiation channel and the coincidence of their optical axes offer the possibility of enhancing the image quality and of increasing the amplitude of the object detection and recognition.

The arrangement of the optical axis of the laser radiation source, which passes through the optical element, at a distance up to the optical axis of the multi-channel optoelectronic system and parallel to the latter makes it possible to separate the high intensity laser radiation of the device, said laser radiation being directed from the device to the object, and the laser radiation of the optoelectronic receiving system.

In order to increase the effective range of the range finder and to increase the accuracy of the sighting, the optical element is designed with the aperture that is intended for the output of the laser radiation.

The replacement of the receiving channel for the visible radiation in the visualization system by means of the dual channel optoelectronic system ensures the required image quality under severe weather conditions, especially at dusk, at night and in fog, and the remote search of the object of the measurement.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 a schematic diagram of an embodiment of the present visualization system, wherein both the receiving channel for the visible radiation and the infrared radiation channel are designed as a multi channel optoelectronic system, which has at least two channels, the optical axes of which are coincident with each other and may be found inside (in the regions of) the input aperture. In this case the channel for the visible radiation is arranged in front of the infrared radiation channel.

FIG. 2 is an embodiment of the present visualization system, in which the optical systems of both the receiving channel for the visible radiation and the infrared radiation channel are superposed on each other and are located on the one optical axis.

FIG. 3 a schematic diagram of an embodiment of the present visualization system, in which the optical axis of the laser radiation source is located at a distance up to the optical axis of the multi channel optoelectronic system and parallel to the latter, and the output laser beam also passes through the optical element.

### DETAILED DESCRIPTION

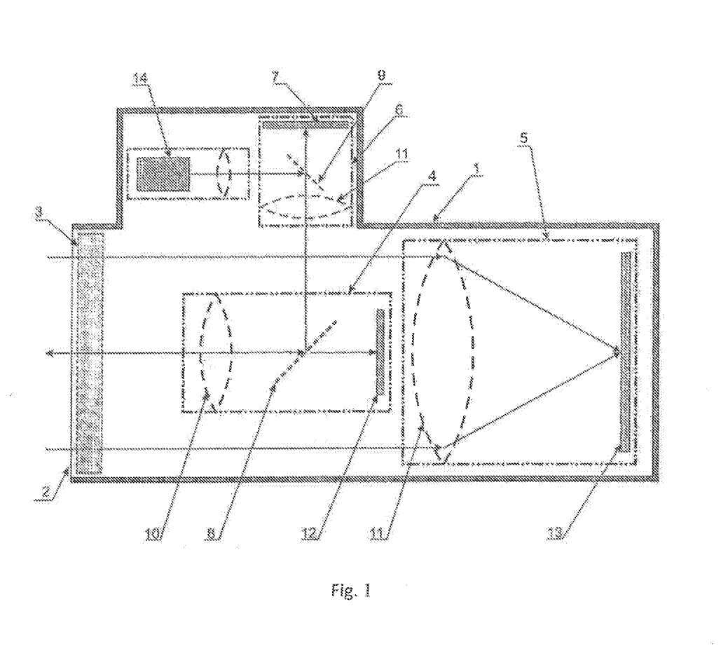

The visualization system according to FIG. 1 includes of a housing 1 having an input aperture 2, which is intended for receiving the radiation from objects; an optical element 3, which is arranged in the input aperture; and an optical system, consisting of a receiving channel for the visible radiation 4, an infrared radiation channel 5 and the channel of a laser range finder 6 with a laser radiation source 14, a photodetector 7, spectral splitters 8, 9, wherein all the channels are optically coupled to each other.

Both the receiving channel for the visible radiation 4 and the infrared radiation channel 5 are formed as a multi channel optoelectronic system with at least two channels, the optical axes of which are coincident with each other (not shown in the drawing) and may be found inside the input aperture 2. At the same time the channels operate simultaneously.

The optical element 3 is made from a material that transmits the radiation in the working range of the photodetectors and is intended for hermetically sealing the system. The element can be used to correct the spectral composition of the input radiation.

Depending on the process engineering possibilities, zinc selenide or zinc sulfide may be used, for example, as the material that transmits the radiation in the working range of the photodetectors of the complex. In addition, zinc selenide or zinc sulfide guarantees the wide passband, the low scattering coefficient, high mechanical properties, the low price of the optical element, and the high weather resistance.

Depending on the technical tasks and the process engineering possibilities, the optical element 3 may have the shape of a circle or parts of a circle, the shape of an oval, a rectangle or their combination.

Each channel of the multi channel optoelectronic system comprises a respective focussing device 10 and 11, and the photodetectors 12 and 13, which are necessary for receiving the image and for transferring said image to the display (it is possible to use the device as an intermediate image processing device).

Typically the TV photocell matrix is used as the photodetector 12 of the visible (optical) channel 4; and the Bolometer matrix without cooling is typically used, for example, as the photodetector 13 of the infrared radiation channel 5.

The laser radiation source 14 that can be used includes any source of coherent pulse radiation in the range of the visible light and the infrared light, in the ranges of the passband of the multi channel optoelectronic system, for example, a semiconductor laser, a Nd:YAG solid state laser, or a HeNe gas laser.

The light splitters can be arranged in the channel of the laser range finder. In this case said light splitters are configured as the light splitting plate 8 and/or 9, and are housed between the photodetector of the channel of the laser range finder 7 and the photodetector 12 of the channel for the visible radiation 4.

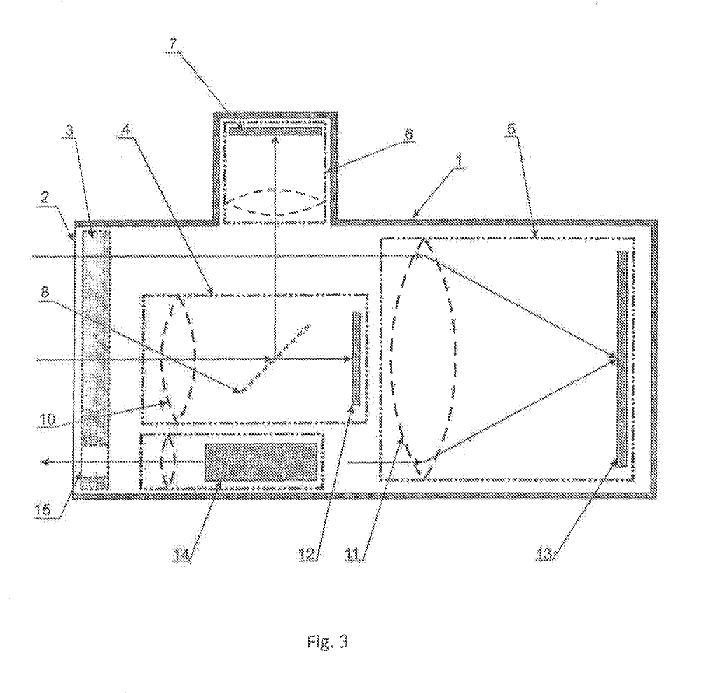

In the event that the laser beam is parallel to the optical axis of the multi channel optoelectronic system (FIG. 3), then only the one light splitting plate 8 is used.

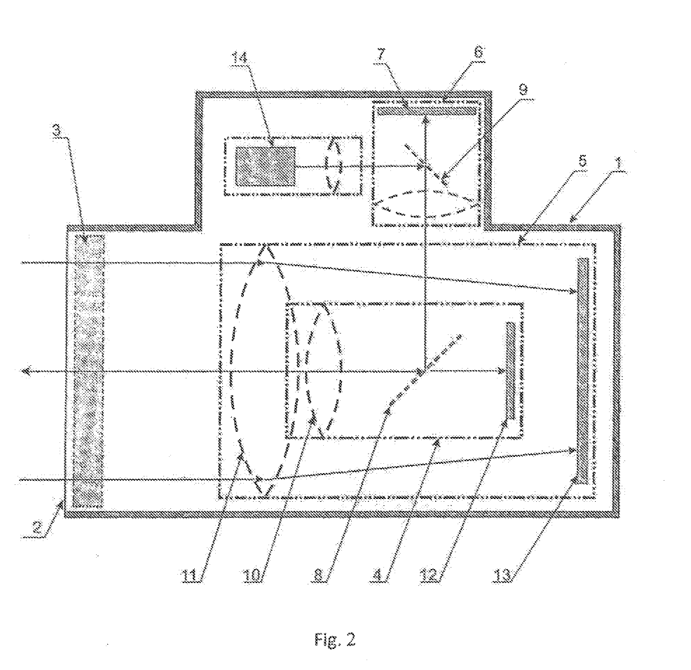

If the beam of the laser radiation source 14 is coincident with the optical axis of the multi channel optoelectronic system (FIG. 2), then two light splitting plates 8 and 9 are used, since the purpose is to combine the output beam together with the main optical axis of the visualization system.

Each radiation sensor 7 is used as the detector of the laser radiation of the channel 6; and said radiation sensor is sensitive to the radiation spectrum of the laser.

When the design according to FIG. 3 is used, the optical element 3 is configured with the aperture 15 that is intended for the output of the laser radiation. The net result of this arrangement is that the high intensity laser radiation, which is directed from the device to the object, is separated from the optoelectronic receiving system.

Depending on the process engineering tasks and the possibilities of production, three embodiments of the visualization system are possible. Schematics elucidating the underlying principle of the visualization system are disclosed in FIGS. 1 through 3.

The claimed visualization system has the following functions (FIGS. 1, 2).

The light flux passes from the object into the input aperture 2, which is intended for receiving the radiation from objects, and into the optical element 3, which is disposed in the aperture. Then the light flux is transmitted into the input of the multi channel optical system, which consists of the channel for the visible radiation 4 and the infrared radiation channel 5, and passes into the photodetector 12 of the visible (optical) channel and the photodetector 13 of the infrared radiation channel 5.

Since the direction of the visible flux and the thermal flux is the same and since the optical axes of the photodetectors 12, 13 may be found on the one optical axis, which is coincident with the input aperture 2 of the system, the high image quality of both the thermal image as well as the visible image and the high selectivity of the visualization system are achieved.

After the signal processing by means of the respective circuits, the output signal is fed to the display (not shown in the schematic diagrams).

The sighting is performed (the direction of the object is determined) after the image of the object, which is formed, according to the data of the visible channel and the thermal channel, on the display (not shown in the drawing).

The laser range finder has the following functions.

The laser beam of the laser radiation source 14 is guided to the object by means of the spectral splitters 8 and/or 9, the optical system of the channel for the visible radiation 4 and the optical element 3.

The laser beam reflected from the object passes into the input aperture 2, which is intended for receiving the radiation, and into the optical element 3, which is arranged in this aperture, and thereafter this beam is transmitted into the input of the optical system, which consists of the receiving channel for the visible radiation 4 and the channel of the laser range finder, and passes into the respective photodetectors 7 and 12.

Thereafter the signals are processed by means of a computer (not shown in the drawing); and the result that is obtained is captured and displayed on the display.

In the embodiment of the optical element 3 according to the schematic (FIG. 3), the output radiation of the laser 14 is directed directly through the aperture 15 in the optical element 3 parallel to the optical axis of the multi channel optoelectronic system to the object. Such an arrangement reduces the entire scattering of the radiation in the optical elements of the visualization system and minimizes the noise. The flow of the laser beam that is reflected from the object enters into the input aperture 2, and thereafter it is processed in accordance with the same procedure that is described in the previous embodiments (FIGS. 1, 2).

The tests that were conducted day and night showed that the claimed visualization system allows the objects to be observed and allows the distances of the objects to be measured within the limits of 2.5 km.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-6. (canceled)

7. A visualization system, comprising:
a housing having an input aperture through which radiation from objects passes;
an optical system including
a visible radiation channel having a visible radiation optical axis and a visible radiation photodetector,
an infrared radiation channel having an infrared radiation optical axis and a infrared radiation photodetector, and
a laser range finder channel having a laser radiation source having a laser radiation source optical axis, a laser radiation photodetector and spectral splitters; and
an optical element located in the input aperture, the optical element being made from a material that transmits radiation in a working range of the photodetectors and hermetically sealing the system
wherein
the visible radiation channel is arranged in a region of the input aperture with the visible radiation channel optical axis and an optical element optical axis being coincident with the infrared radiation channel optical axis.

8. The visualization system as claimed in claim 7, wherein
the optical element is made from zinc selenide or zinc sulfide.

9. The visualization system as claimed in claim 7, wherein
the visible radiation channel is arranged between the optical element and the infrared radiation channel.

10. The visualization system as claimed in claim 7, wherein
the visible radiation channel and the infrared radiation channel are superimposed on each other.

11. The visualization system as claimed in claim 7, wherein
the laser radiation source optical axis is arranged parallel and at a distance to the visible radiation channel optical axis and passes through the optical element.

12. The visualization system as claimed in claim 11, wherein
the optical element includes an aperture through which laser radiation from the laser radiation source passes.
